(19) United States
(12) Patent Application Publication
(10) Pub. No.: US 2026/0206807 A1
(43) Pub. Date: Jul. 23, 2026

(54) FAST-DISINTEGRATING FLAVORING COMPOSITION FOR INSTANT FOODS

(71) Applicant: V. MANE FILS, LE BAR-SUR-LOUP (FR)

(72) Inventors: Annaïg FALC'HUN, Grasse (FR); Jean-Michel HANNETEL, Grasse (FR)

(21) Appl. No.: 19/143,008

(22) PCT Filed: Dec. 29, 2023
(86) PCT No.: PCT/EP2023/087967

§ 371 Date: Jun. 25, 2025

(30) Foreign Application Priority Data
Dec. 30, 2022 (EP) 22307070.7

(51) Int. Cl. A23L 23/10; A23L 27/00; A23L 33/115; A23L 33/125; A23L 33/22; A23P 10/25; A23P 20/15; A23P 30/20

(52) U.S. Cl. CPC A23L 23/10; A23L 27/88; A23L 33/115; A23L 33/125; A23L 33/22; A23P 10/25; A23P 20/15; A23P 30/20

(57) ABSTRACT

A shaped flavoring composition for instant foods is provided, along with a method for making same. The shaped flavoring composition includes a core and, optionally an outer coating layer, wherein the core includes 10 to 40 weight % of native starch or flour void of any pregelatinized starch; 0 to 20 weight % of a plasticizer selected from the group consisting of glycerin, propylene glycol, water, and combinations thereof; 30 to 50 weight % of crystalline ingredients selected from sodium chloride, potassium chloride, monosodium glutamate, and combinations thereof; 0.5 to 50 weight % of amorphous solid flavor ingredients; 0 to 5 weight % dietary fibers; 10 to 25 weight % of an edible fat composition having a melting point between 30° C. to 60° C.; and the optional outer coating layer includes a hydrocolloid gelling agent, or a meltable fat having a melting point between 40° C. to 86° C.

### FIELD OF THE INVENTION

The present invention relates generally to flavoring, and more particularly to a fast-disintegrating flavoring composition for instant foods.

### BACKGROUND OF THE INVENTION

Instant foods, such as instant noodles, are traditionally packaged in two types of formats: in sachets or in cups. For example, the instant noodle product includes unflavored noodles and two to three individual sachets made of aluminum or plastic, which contain oil, spicy sauce, and/or powdered aromatics. Typical sachets in these instant noodle foods contain about 2.8 g of oil and/or spicy sauce and about 9.5 g of powdered aromatics, for about 12 g of flavoring ingredients. These small individual sachets are usually difficult to recycle. They therefore represent a non-negligible source of waste and plastic pollution. To date, there is no solution to replace all 12 g of oil, spicy sauce, and powdered aromatics in a stable form and without waste-generating packaging.

“Bouillon” is a term used for a broth that has been condensed and is available as cubes, granules, powders, pastes, or liquids. The use of bouillon to provide salt, meat, and vegetable flavorings in soups, gravies, sauces, instant foods, and other similar food products is well known.

The most common type of bouillon is a cube produced by compressing the bouillon ingredients under relatively high pressure to produce a dense bouillon cube. Such cubes are presently being produced by Hormel Foods Corp. (HERB-OX®), Kraft Heinz Co. (WYLER'S®), and Nestlé S.A. (MAGGI®). These dense bouillon cubes are made by compressing the bouillon powder using a modified pharmaceutical-type tablet press, yielding densities greater than 1.5 g/cm³ and typically contain less than 10 weight percentage (wt %) of fat. Such cubes are typically wrapped in foil to minimize water absorption by one or more hygroscopic bouillon ingredients and take several minutes to dissolve in boiling water.

Another form of bouillon is a particulate composition, such as a powder or granules. However, many of such powders or granules are also hygroscopic and clump/stick together over time. EP2104435B1 describes a particulate composition for preparing bouillon, soups, sauces, gravies, or for use as a seasoning. The particulate composition is prepared by forming a mixture of at least two of the following components 30-70 wt % salt, 10-45 wt % monosodium glutamate, 5-20 wt % sugar, 2-15 wt % starch, and 7-15 wt % fat; making particles of the mixture, and then grinding them to a particle dimension between 200 μm and 2 mm. While the smaller particle diameters facilitate quicker dissolution, the hygroscopic nature of many ingredients (e.g., salt, MSG, etc.) necessitates packaging the powder/granules in sealed or resealable containers.

Finally, another type of bouillon flavor is provided in a liquid form. Liquid bouillon is primarily water-based and therefore quickly disperses and dissolves in water, but generally is provided in a squeezable or pourable container, and thus not amenable to instant noodle foods without waste-generating packaging.

Accordingly, there is a need for new fast-disintegrating flavoring compositions that do not require separate packaging and yet quickly dissolve in hot water and instant foods.

### SUMMARY OF THE INVENTION

Certain aspects of the present disclosure are described in the appended claims. There are additional features and advantages of the subject matter described herein. They will become apparent as this specification proceeds. In this regard, it is to be understood that the claims serve as a brief summary of varying aspects of the subject matter described herein. The various features described in the claims and below for various embodiments may be used in combination or separately. For example, specified ranges may be inclusive of their recited endpoints, unless explicitly excluded. Any particular embodiment need not provide all features noted above, nor solve all problems or address all issues noted above.

According to an embodiment of the invention, a shaped flavoring composition for instant foods is provided. The shaped flavoring composition comprises a core and, optionally an outer coating layer, wherein the core comprises 10 to 40 weight % of native starch or flour void of any pregelatinized starch; 0 to 20 weight % of a plasticizer selected from the group consisting of glycerin, propylene glycol, water, and combinations thereof; 30 to 50 weight % of crystalline ingredients selected from sodium chloride, potassium chloride, monosodium glutamate, and combinations thereof; 0.5 to 50 weight % of amorphous solid flavor ingredients; 0 to 5 weight % dietary fibers; 10 to 25 weight % of an edible fat composition having a melting point between 30° C. to 60° C.; and the outer coating layer comprises a hydrocolloid gelling agent, or a meltable fat having a melting point between 40° C. to 86° C., wherein weight % is based on the weight of the core of the shaped flavoring composition. The native starch or flour, plasticizer, crystalline ingredients, amorphous solid flavor ingredients, dietary fibers, and edible fat are mixed to form a dough, extruded, and formed into a general shape, and optionally coated to provide the shaped flavoring composition for instant foods. The shaped flavoring composition has a hardness of 150 grams-force to 2,000 grams-force.

In accordance with another embodiment of the invention, a process for preparing a shaped flavoring composition for instant foods is provided, where the shaped flavoring composition comprises a core, and optionally, an outer coating layer. The process comprises:
forming a premixture comprising a) 10 to 40 weight % of native starch or flour, which is void of any pregelatinized starch; b) 0 to 20 weight % of a plasticizer selected from the group consisting of glycerin, propylene glycol, water, and combinations thereof; c) 30 to 50 weight % of crystalline ingredients selected from sodium chloride, potassium chloride, monosodium glutamate, and combinations thereof; d) 0.5 to 50 weight % of amorphous solid flavor ingredients; and e) 0 to 5 weight % dietary fibers;
mixing 10 to 25 weight % of a melted form of an edible fat (f) into the premixture to form a dough, wherein the edible fat has a melting point between 30° C. to 60° C.;
extruding and forming the dough into a general shape of the shaped flavoring composition; and
optionally, applying an outer coating layer to the shaped composition, wherein the outer coating layer comprises g) a hydrocolloid gelling agent, or h) a meltable fat having a melting point between 40° C. to 86° C.; and
optionally, drying the shaped flavoring composition at a temperature less than the melting point of the edible fat (f) either prior to or after applying the optional outer coating layer;
wherein weight % is based on the weight of the core of the shaped flavoring composition; and
wherein the shaped flavoring composition has a hardness of 150 grams-force to 2,000 grams-force.

### BRIEF DESCRIPTION OF THE DRAWINGS

The accompanying drawing, which are incorporated in and constitute a part of this specification, illustrate embodiments of the invention and, together with a general description of the invention given above, and the detailed description given below, serve to explain the invention. It will be appreciated that for purposes of clarity and where deemed appropriate, reference numerals have been repeated in the figures to indicate corresponding features.

FIG. 1 is a graph showing exemplary texture analysis output for two shaped flavoring compositions (Examples 12 and 13), in accordance with an embodiment of the present invention;

FIG. 2 is compilation of photographs taken of whole and cut portions of two shaped flavoring compositions (Examples 12 (2A/2B) and 13 (2C/2D), in accordance with an embodiment of the present invention; and

FIG. 3 shows cross-sectional views of exemplary embodiments of the shaped flavoring compositions, where 3A and 3C are without an outer coating layer and 3B and 3C include an outer coating layer; where 3C and 3D include one or more rapidly-solubilized, flavor-containing capsules.

### DETAILED DESCRIPTION

Unless otherwise explained, all technical and scientific terms used herein have the same meaning as commonly understood by one of ordinary skill in the art to which this disclosure belongs. In case of conflict, the present specification, including explanations of terms, will control. The singular terms “a,” “an,” “at least one,” and “the” include plural referents unless context clearly indicates otherwise. Similarly, the word “or” is intended to include “and” unless the context clearly indicates otherwise. The term “comprising” means “including;” hence, “comprising A or B” means including A or B, as well as A and B together.

In accordance with embodiments of the present invention, a shaped flavoring composition for instant foods is provided. The shaped flavoring composition includes a core, and optionally an outer coating layer. The core includes a blended mixture of 10 to 40 weight % native starch or flour; 0 to 20 weight % of a plasticizer selected from the group consisting of glycerin, propylene glycol, water, and combinations thereof; 30 to 50 weight % crystalline ingredients selected from sodium chloride, potassium chloride, monosodium glutamate, and combinations thereof; 0.5 to 50 weight % amorphous solid flavor ingredients; 0 to 5 weight % dietary fibers; and 10 to 25 weight % edible fat having a melting point between 30° C. to 60° C., wherein weight % is based on the weight of the core of the shaped flavoring composition. When present, the outer coating layer, which is applied to the core of the shaped flavoring composition, comprises a hydrocolloid gelling agent, or a meltable fat having a melting point between 40° C. to 86° C.

In accordance with embodiments of the invention, the core of the shaped flavoring composition comprises a native starch or flour, which is void of any pregelatinized starch, in an amount in the range of 10 weight % to 40 weight % (by weight of the core of the shaped flavoring composition), preferably between 12 weight % to 35 weight %, preferably between 15 weight % to 30 weight %.

As used herein, “native starch” is defined as a starch granule in its native form; isolated from cereals and tubers by physical extraction, purification, and drying of starch milk. The starch according to the invention is selected from the group consisting of maize, waxy maize, high amylose maize, wheat, tapioca, potato, rice, cassava or combinations of these. The starch is selected from the group consisting of native wheat starch, native maize starch, native rice starch, native potato starch, native cassava starch, and combinations of these. The starch utilized in embodiments of the invention is humid starch and comprises between 3% and 25% moisture by weight. For example, the starch may comprise between 4% and 22% moisture by weight, preferably between 7% and 21% moisture, preferably the starch comprises between 10% and 20% moisture by weight (humid starch). In an embodiment, the humid native starch has a water activity of between 0.4 and 0.6 at 20° C., preferably between 0.45 and 0.55 at 20° C. Humid native starch of an appropriate moisture content may be obtained by blending humid and non-humid starches and allowing them to equilibrate. Humid native starches are often available commercially at a lower price than the dry native starch as water needs to be removed from starch in the manufacturing process, humid native starch being effectively a part-finished ingredient.

As used herein, “void of any pregelatinized starch” means that no “pregelatinized starch” is intentionally added to the core of the shaped flavoring composition. Native starch granules include a semi-crystalline form and have a crystallinity varying from 15 to 45%. Another related and prominent feature of a native starch granules is its presence of Maltese cross when observed under polarized light, due to the presence of crystallinity in the native starch. The gelatinization process involves progressively heating native starch granules in the presence of excess of water. When sufficient heat is applied, the granules begin to irreversibly swell and there is a point at which the Maltese cross of the native starch granules disappears. During gelatinization, several events occur simultaneously. There are three distinct stages that occur in the gelatinization process: (i) granular swelling by slow water absorption; (ii) followed by a rapid loss of birefringence via the absorption of large amounts of water by the granules; and (iii) finally, leaching of the soluble portion into the solution. Size, shape of the granule, and the loss of birefringence are the distinctive feature of the gelatinized starch. As noted above and in accordance with embodiments of the present invention, the core of the shaped flavoring composition comprises native starch or flour, which is void of any pregelatinized starch.

In an aspect of the invention, the native starch is provided as a powdered form having a median particle size distribution (Dv50) from 5 microns to 500 microns, preferably 5 microns to 400 microns, preferably 5 microns to 300 microns, preferably 10 microns to 250 microns. In an embodiment, the native starch is provided as a powdered form having a D100 less than 250 microns, such as 200 microns or less, 150 microns or less, 100 microns or less, or 75 microns or less.

As used herein, “flour” is typically obtained from cereals, tubers, roots, legumes and fruits. The native source can include acorn, amaranth, arrowroot, azukibean, banana, barley, breadnut, buckwheat, candlenut, canna, cashew, cassava, cattail, chestnut, chia, chickpea, coconut, corn (maize), cornmeal, cowpea, egusi or other melon seeds, faba bean, filbert, flaxseed, fonio, freekeh, hazelnut, hemp, hyacinth, kaniwa, lentil, lupin, macadamia, millet, moringa, mungbean, oat, pea, peanut, pecan, pistachio, pinto bean, potato, sweet potato, pumpkin seed, quinoa, rice, wild rice, rye, sago, sesame, sorghum, soy, spelt, tapioca, triticale, walnut, or wheats, such as wheat atta, wheat berries and ancient wheats, wheat bulgur, wheat semolina durum, wheat Graham, wheat kamut, or wheat maida, as well high amylopectin or high amylose varieties thereof. The term “flour” also includes high or enriched protein flours. In a preferred embodiment, the flour is obtained from native sources selected from the group consisting of barley, corn, cowpea, pea, quinoa, and wheat.

In an embodiment of the invention, the flour in the core of the shaped flavoring composition of the invention is milled. Milling according to this invention is a process that breaks solid materials into smaller pieces by grinding, crushing, or cutting. Milling can be carried out by any commonly known milling techniques such as roll mill, hammer mill, chopper mill, ball mill, SAG mil, rod mil, or combinations thereof. Preferably, the flour is dry milled. Typically, milling transforms the flour into a more palatable form by reducing the particle size thereof. Milling of the flour has the advantage that it improves the homogeneity of the final product and/or improves the mixing efficiency of the cereal dietary fiber and the other ingredients. Further, it may improve the binding ability between the different ingredients. To ensure that the desired particle size reduction is achieve, the milled flour may be sifted through an appropriately sized mesh. The flour may be briefly heat treated to pasteurize and reduce the risk of bacterial growth in the raw flour.

In an aspect of the invention, the flour is provided as a powdered form having a median particle size distribution (Dv50) from 5 microns to 500 microns, preferably 5 microns to 400 microns, preferably 5 microns to 300 microns, preferably 10 microns to 250 microns, preferably 15 to 100 microns. In an embodiment, the native starch is provided as a powdered form having a D100 less than 500 microns, such as 450 microns or less, 400 microns or less, 350 microns or less, or 300 microns or less.

The particle size Dv50 is used in the conventional sense as the median of the particle size distribution. Median values are defined as the value where half of the population reside above this point, and half resides below this point. The Dv50 is the size in micrometer that splits the volume distribution with half above and half below this diameter. The particle size distribution may be measured by laser light scattering, microscopy or microscopy combined with image analysis. For example, the particle size distribution may be measured by laser light scattering. Since the primary result from laser diffraction is a volume distribution, the Dv50 cited is the volume median. Particle size and particle size distribution may be measured by laser diffraction using a Malvern Mastersizer® particle size analyzer.

The D100 is a less precise characteristic of particle sizes for a powdered material, and merely identifies that the entire sample population is less than a specified value. Typically, the D100 is obtained by sifting a sample of the powdered material through a screen of specific mesh, which will exclude particles having larger diameters than the mesh pores. For example, a reported D100 of 250 microns would mean that the entire sample would filter through a 60 mesh screen, or a reported D100 of 74 micron would mean that the entire sample would filter through a 200 mesh screen.

In accordance with embodiments of the invention, the core of the shaped flavoring composition may comprise a plasticizer selected from the group consisting of glycerine, propylene glycol, water, and combinations thereof. For example, in an embodiment, the plasticizer comprises water, which may be selected from a variety of water qualities, e.g., process water, distilled water, osmosis water, etc. In another embodiment, the plasticizer comprises glycerin. The plasticizer may further comprise sugars, sugar alcohols, or other ingredients that are soluble/dispersible in the plasticizer. Non-limiting examples of such plasticizer ingredients include sorbitol, mannitol, sucrose, glucose, or the like. In an embodiment, the shaped flavoring composition comprises 0 weight % to 20 weight % (by weight of the core of the shaped flavoring composition) added water. In an embodiment, the shaped flavoring composition comprises 0 weight % to 20 weight % (by weight of the core of the shaped flavoring composition) glycerin. In an embodiment, the shaped flavoring composition comprises 0 weight % to 20 weight % (by weight of the core of the shaped flavoring composition) propylene glycol. In an embodiment, the plasticizer is between 0 weight % and 50 weight %, based on the combined weight of the native starch, flour, and plasticizer. In an embodiment, the plasticizer may be present in an amount of 0 weight %, 1 weight %, 5 weight %, 10 weight %, 15 weight %, or 20 weight %, or in a range between any two of the foregoing, wherein weight % is based on the weight of the core of the shaped flavoring composition.

In accordance with embodiments of the invention, the core of the shaped flavoring composition comprises 30 weight % to 50 weight % (by weight of the core of the shaped flavoring composition) crystalline ingredients selected from the group consisting of sodium chloride, potassium chloride, monosodium glutamate, and combinations thereof. For example, the crystalline ingredients may be present in the core of the shaped flavoring composition in an amount in the range of 30 weight % to 50 weight % (by weight of the core of the shaped flavoring composition), preferably between 28 weight % to 48 weight %, preferably between 25 weight % to 45 weight %, preferably between 20 weight % to 40 weight %, preferably between 25 weight % to 50 weight %.

In accordance with embodiments of the invention, the core of the shaped flavoring composition comprises 0.5 weight % to 50 weight % (by weight of the core of the shaped flavoring composition) amorphous solid flavor ingredients. As used herein, the term “amorphous solid flavor ingredients” means flavor-imparting amorphous solid ingredients, such as yeast extract, vegetable powder, animal powder, insect powder, vegetable extract, bacterial extract, animal extract, reaction flavor, hydrolyzed plant protein, acid, garnishes, herbs, spices, sweeteners, or combinations thereof. In an embodiment, the amorphous solid flavor ingredients are selected from the group comprising yeast extract, chicken extract, onion powder, garlic powder, celery root powder, tomato powder, bacterial extract, reaction flavor, sweeteners, or combinations thereof. Vegetable powder means at least one ingredient of onion powder, garlic powder, tomato powder, celery root powder or a combination thereof. Garnishes, herbs, spices, or a combination thereof are selected from the group comprising pieces of parsley, celery, fenugreek, lovage, rosemary, marjoram, dill, tarragon, coriander, ginger, lemongrass, curcuma, chili, ginger, paprika, mustard, garlic, onion, turmeric, tomato, coconut milk, cheese, oregano, thyme, basil, chilies, paprika, pimento, jalapeno pepper, white pepper powder and black pepper or combinations of these. Animal powder means at least one ingredient of meat powder, fish powder, crustacean powder, milk powder, or combinations thereof. Insect powder means crickets, beetles, grasshopper, worms, and the like. Meat powder includes poultry powder, egg powder, beef powder, or pork powder. Animal extract includes at least one ingredient of meat extract, fish extract, crustacean extract, or combination thereof. Sweeteners include natural sweeteners, such as maltodextrin, honey, sugar, erythritol, monk fruit, or molasses; or non-nutritive sweeteners, such as aspartame, sucralose, acesulfame K, saccharin, xylitol, or steviols. In an embodiment, the core of the shaped flavoring composition comprises 0.5 weight % to 50 weight % amorphous solid flavor ingredients (by weight of the core of the shaped flavoring composition), preferably 0.5 to 45 weight %, preferably 1 to 40 weight %, preferably 2 to 40 weight %, preferably 1 to 35 weight %, preferably 2 to 35 weight %, preferably 3 to 35 weight %, preferably 5 to 35 weight %, preferably 9 to 35 weight %, preferably 10 to 30 weight %, preferably 10 to 25 weight %, preferably 10 to 20 weight %, preferably 5 to 25 weight %, for further example 10 to 35 weight % (by weight of the core of the shaped flavoring composition).

The amorphous solid flavor ingredients, as well as other flavors and flavoring agents, may be delivered or provided in various encapsulation technology forms, such as powders, granules, and/or seamless capsules. MANE's N-CAPTURE® encapsulation technologies can provide a barrier between the flavor or flavor ingredient, as well as provide a controlled release. Exemplary flavor-containing products produced by MANE include N-CAPTURER SD, N-CAPTURER MSD, N-CAPTURER CS, N-CAPTURER PPM, N-CAPTURER TS, POWERGRAN® GR, POWERGRAN® GL, POWERGRAN® CE, POWERGRAN® PE, POWERGRAN CORE®, and POWERCAPS®.

In an embodiment, one or more suitable rapidly-solubilized, flavor-containing capsule(s) is/are included in the core of the shaped flavoring composition, as described in WO 03/045166 A2 and U.S. Pat. No. 7,754,239 B2, which is incorporated by reference in its entirety. The rapidly-solubilized, flavor-containing capsule comprises a core and at least one envelope (shell) comprising at least one film-forming polymer, characterized in that it exhibits a total solubilization time of its envelope of less than or equal to 85 s, according to a test A which is defined below.

In the test A, a dissolving device having a continuous flow cell as described in the French or American Pharmacopoeia (USP XXIII, 724) is used. A continuous flow cell is preferred rather than a conventional dissolving device, due to the fact that the content of the capsule may be completely lipophilic and therefore sometimes float at the surface and not always make it possible to obtain homogeneous samples over time. The procedure used in the test A is as follows: a single capsule is introduced into the cell of a dissolving device as mentioned in the previous paragraph, which cell is crossed by an aqueous flow maintained at 37+/−0.5° C., pH 6.5, 50 ml/min. The capsule is then observed through the cell with the naked eye, making it possible to define a piercing time (opening of the envelope), a breaking up time (total release of its content) and a total solubilization time (disappearance of the envelope of the capsule). In the present patent application, the term “solubilization” is intended to mean the solubilization of the envelope of the capsule.

The total solubilization time for the envelope (shell) of the rapidly-solubilized, flavor-containing capsule is less than or equal to 85 s according to the test A, preferably less than or equal to 80 s, more preferably less than or equal to 70 s. The breaking up time of the rapidly-solubilized, flavor-containing capsule is less than or equal to 30 s, preferably less than or equal to 20 seconds, more preferably less than or equal to 15 s.

Preferably, the rapidly-solubilized, flavor-containing capsule is spherical or substantially spherical, preferably perfectly spherical. It is variable in diameter, preferably from 0.8 to 8 mm in diameter. This diameter will depend on the use, and may be easily chosen by the person skilled in the art. The weight of a capsule according to the invention is variable; it may be from 0.3 to 280 mg.

The envelope (shell) of the rapidly-solubilized, flavor-containing capsule comprises at least one film-forming polymer chosen from the film-forming polymers used in the food or pharmaceutical field and known to the person skilled in the art, in particular gelatins, polyvinyl alcohols (PVAs), natural gums (gum arabic, guar gum, carob gum, gellan gum, pullulan gum, etc.), carreghenans, cellulose derivatives, starch derivatives, etc.

The shell of the rapidly-solubilized, flavor-containing capsule also comprises at least one plasticizer, which may be of the glycerol, sorbitol, maltitol, triacetine or PEG type, or another polyol with plasticizing properties, and preferably at least one acid of the monoacid, diacid or triacid type, in particular citric acid, fumaric acid, malic acid, etc. The use of at least one such acid in particular makes it possible to provide microbiological stability of the envelope of the capsule and to adjust its physicochemical and sensory properties during dissolving thereof (pH, solubility, etc.).

The thickness of the envelope of the rapidly-solubilized, flavor-containing capsule is between approximately 30 and approximately 100 μm, preferably from 50 to 65 μm. The envelope represents from 8 to 30% of the weight of the capsule, preferably 8 to 15%.

The core of the rapidly-solubilized, flavor-containing capsule is preferably composed of a mixture of molecules which are hydrophobic. The core may be composed of one or more lipophilic solvents conventionally used in the food and beverage industries. They may in particular be triglycerides, and in particular triglycerides of caprylic and capric acid, mixtures of triglycerides such as vegetable oil, olive oil, sunflower oil, corn oil, groundnut oil, grapeseed oil, wheatgerm oil, etc. The amount of lipophilic solvent in the core of the rapidly-solubilized, flavor-containing capsule is of the order of 0.01 to 90% of the weight of the capsule, preferentially 25 to 75%.

The core of the rapidly-solubilized, flavor-containing capsule may also comprise one or more aromatic or fragrancing molecules as conventionally used in the formulation of flavoring or fragrancing compositions. Mention will in particular be made of aromatic, terpenic and/or sesquiterpenic hydrocarbons, and more particularly essential oils, oleoresins, alcohols, aldehydes, phenols, carboxylic acids in their various forms, aromatic acetals and ethers, nitrogenous heterocycles, ketones, sulfides, disulfides and mercaptans which may be aromatic or nonaromatic. Advantageously, upon dissolution of the envelope (shell) of the rapidly-solubilized, flavor-containing capsule, the oily core may provide an appealing visual of tiny oily droplets to the instant food or beverage, along with an impactful release of its flavor/fragrant volatiles. The core may also comprise one or more “sensate” aromatic agents. The core of a the rapidly-solubilized, flavor-containing capsule represents by weight 70 to 92% of the capsule, preferably 80 to 92%, more preferably 85 to 92%.

Several methods of producing capsules are known. Mention will be made of the interfacial polymerization or coacervation techniques which make it possible to obtain capsules which are generally small in size, generally less than 1 mm, for a perfectly spherical shape, capsules with a larger granulometry exhibiting irregularities in sphericity. Mention may also be made of the method of producing soft capsules which makes it possible to obtain capsules several millimeters in diameter, obtained by welding two hemispherical envelopes.

In a preferred embodiment, the rapidly-solubilized, flavor-containing capsule is a seamless capsule, which may be prepared by co-extrusion. The method of co-extrusion consists in co-extruding two liquids, one external and hydrophilic (which will become the envelope), the other central and lipophilic (which will become the core), in an oily organic medium, which leads to the formation of spherical capsules with no welding joint. Systems such as disclosed in EP 1240883 or in Freund's U.S. Pat. Nos. 5,186,948, 5,223,185, 5,387,093 and 5,882,680 illustratively can be used.

In an embodiment, the shell of the rapidly-solubilized, flavor-containing capsule comprises 70% to 90% high bloom gelatin (e.g., pork, beef, or fish); 10% to 30% of one or more plasticizer, which may be selected from the group consisting of glycerol, sorbitol, maltitol, triacetine, polyethelene glycol or other polyol with plasticizing properties, and combinations thereof; and optionally, 0 wt % to 3% of one or more carboxylic acid, which may be a monoacid, diacid, or triacid type, in particular citric acid, fumaric acid, malic acid, etc., where % is a weight percentage base on the entire weight of the shell material.

The rapidly-solubilized, flavor-containing capsule may be mixed into a premixture of the dough prepared to form the core of the shaped flavoring composition or inserted into a prepared dough.

In accordance with embodiments of the invention, the core of the flavoring composition comprises between 0 to 5 weight % dietary fibers, based on the weight of the core of the shaped flavoring composition. As used herein, “dietary fibers” are particulate substances comprising at least 50 weight % fibers resistant to digestion (hydrolysis) by the alimentary enzymes of humans. Without being bound by any particular theory, it is believed the dietary fibers function as dispersing agents and/or disintegrating agents, which facilitates the desired quick dissolution of the shaped flavoring composition. The dietary fibers from edible plant cells, polysaccharides, lignin, and associated substances may be derived from vegetables, fruits, cereals, seeds, or combinations thereof. Dietary fibers are selected from at least one of cereal grains, carrot, beetroot, pumpkin, citrus, bamboo, tomato, bell pepper, leek, ginger, onion, kale, parsnip, celery, cucumber, broccoli, kohlrabi, asparagus, psyllium, or combinations thereof. Preferably, the dietary fibers are derived from cereal grains or psyllium husks. In an embodiment, the flavoring composition comprises between 0.5 to 5 weight %, such as 0.6 to 4.5 weight %, 1 to 4 weight %, 0.8 to 3 weight %, or 1 to 2 weight %.

As used herein, “hull” or “bran” are the outer protective layers of grains or seeds. Commercial ground hull or bran preparations contain variable amounts of insoluble fibers, e.g., cellulose, hemicellulose, cross-linked cellulose, and lignin, depending on the variety of cereal and the milling process. Ground hulls or ground brans are mainly obtained from cereal grains, such as barley, buckwheat, bulgur, canary grass, common oat (Avena sativa), corn, millet, rice (e.g., black rice, brown rice and/or wild rice), rye, sorghum, spelt, teff, triticale, wheat and, wheat berries, as well as pseudo-cereals. Examples of pseudo-cereals include amaranth, buckwheat, tartar buckwheat and quinoa. Examples of seeds include the seeds of the genus Plantago, which are commonly known as psyllium or ipaghual. Unless the context herein clearly indicates, otherwise, the term “cereal” as used herein includes both cereal and pseudo-cereals; and the hull or bran used herein may be from either type. In general, the source of grain that is used depends on the product to which it is to be added, since each grain has its own taste profile.

In an embodiment of the invention, the cereal dietary fiber is selected from the group consisting of rice, wheat, buckwheat, corn, oat, barley, psyllium husks, and a combination thereof. In an embodiment of the invention, a rice-derived dietary fiber may usefully comprise components in the following amounts: dietary fibers 65% to 79% (w/w), proteins 1% to 4% (w/w), fat 0.5% to 5% (w/w), and ash 18% to 25% (w/w). In another embodiment, a psyllium husk dietary fiber may usefully comprise approximately 80% (w/w) dietary fibers of which about 66% (w/w) is soluble dietary fiber and 14% (w/w) is insoluble dietary fiber, and ash content is about 4% (w/w).

The cereal dietary fiber in the composition of the invention may be optionally heat-treated and can be coarse or powdered to reduce its particle size and achieve the particle properties defined. In a preferred embodiment, the cereal dietary fiber is powdered rice (Oryza sativa) hull, psyllium husks, or a combination thereof. Methods of producing powdered cereal dietary fiber are known to the person skilled in the art.

In an embodiment of the invention, the cereal dietary fiber in the core of the shaped flavoring composition of the invention is milled. Milling can be carried out by any commonly known milling techniques such as roll mill, hammer mill, chopper mill, ball mill, SAG mil, rod mil, or combinations thereof. Preferably, the cereal dietary fiber is dry milled. Typically, milling transforms the cereal dietary fiber into a more palatable form by reducing the particle size thereof. Milling of the cereal dietary fiber has the advantage that it improves the homogeneity of the final product and/or improves the mixing efficiency of the cereal dietary fiber and the other ingredients. Further, it may improve the binding ability between the different ingredients.

The dietary fibers (e.g., cereal hull, cereal bran, or combination thereof) are in a powdered form having a median particle size distribution (Dv50) in a range from 5 microns to 500 microns, preferably 5 microns to 400 microns, preferably 5 microns to 300 microns, preferably 10 microns to 250 microns. In an embodiment, the dietary fiber is provided as a powdered form having a D100 less than 250 microns, such as 200 microns or less, 150 microns or less, 100 microns or less, or 75 microns or less.

In accordance with embodiments of the invention, the core of the shaped flavoring composition includes 10 to 25 weight % (based on the weight of the core of the shaped flavoring composition) edible fat having a melting point between 30° C. to 60° C. As used herein, the term “edible fat” refers any fat which is food grade. Edible fat may comprise both solid fat and liquid fat, including oil(s). The edible fat may be an animal fat, fish fat, and/or vegetable fat. The edible fat may for example comprise animal fat, such as dairy fat (e.g., butter), or fat from pork, chicken, or beef, but also vegetable fats, such as coconut oil, olive oil, palm oil, or rapeseed oil may be used. Also fractions of these edible fats may be used. A combination of fats is also possible, so long as the edible fat composition has a melting point between 30° C. to 60° C. In a further embodiment, the edible fat according to this invention means at least one ingredient of tropical fat, fractionated tropical fat, fractionated beef fat, fractionated chicken fat, algae fat, or shea butter, or interesterified shea butter. The main components in these edible fats are triglycerides. Preferred edible fats used in the shaped flavoring composition are hydrogenated coconut fat and/or beef fat.

In accordance with embodiments of the invention, the core of the shaped flavoring composition includes an edible fat content in a range from 10 weight % to 25 weight percent, wherein weight % is based on the weight of the core of the shaped flavoring composition. Preferably, the edible fat content in the core of the shaped flavoring composition is at most 25 weight %, preferably at most 20 weight %, more preferably at most 15 weight %. Preferably the fat content in the shaped flavoring composition is 10 weight % or more, preferably at least 12 weight %. Preferably, the amount of edible fat ranges from 12 to 20 weight %, such as from 13 to 18 weight %, wherein weight % is based on the weight of the core of the shaped flavoring composition.

In an embodiment, the edible fat is a solid at a temperature of 20° C., preferably solid at a temperature of 25° C. The term “solid at a temperature of 20° C.” means that the fat, stored at this temperature, maintains its shape. Fats and oils are the chief component of animal adipose tissue and many plant seeds. In accordance with an embodiment, the edible fat has a solid fat content greater than 2% at 30° C., preferably it has a solid fat content greater than 5% at a temperature of 30° C., preferably it has a solid fat content greater than 10% at a temperature of 30° C. The solid fat content of a fat may be measured by pulsed NMR.

In accordance with an embodiment of the present invention, the core may further comprise liquid flavorings, such as essential oils, botanical extracts, or the like. Non-limiting examples of liquid flavorings include, garlic oil, pepper oils or oleoresins, thyme oil, rosemary oil, or other flavoring agents dispersed in oil carriers, such as medium-chain triglycerides.

The core may further comprise other functional ingredients, such as antioxidants, acidulants, neutralizers, colorants, or visual aids (e, g, herb flakes). The term “antioxidant” is understood to include any one or more of substances that inhibit oxidation or reactions promoted by Reactive Oxygen Species (“ROS”) and other radical and non-radical species. Additionally, antioxidants are molecules capable of slowing or preventing the oxidation of other molecules. Non-limiting examples of antioxidants include coenzyme Q10 (“CoQ10”), flavonoids, glutathione Goji (wolfberry), hesperidine, lactowolfberry, lignan, lutein, lycopene, polyphenols, selenium, vitamin B1, vitamin B6, vitamin B12, vitamin C, vitamin D, vitamin E, zeaxanthin, synthetic antioxidants, citric acid or combinations thereof. The antioxidant may be selected from the group consisting of ascorbyl palmitate, rosemary extract, citric acid, green tea extract, tocopherol, butylated hydroxytoluene (BHT), butylated hydroxyanisole (BHA), tert-butylhydroquinone (TBHQ), and combinations of these. The antioxidant in the composition of the invention may be a mixture of a green tea extract and a rosemary extract. The antioxidant in the composition of the invention may be rosemary extract. One exemplary antioxidant is OxiKan™, which is a range of natural antioxidants extracted from rosemary and produced by MANE KANCOR INGREDIENTS PRIVATE LTD (Kerala, India).

Once the ingredients of the core are mixed (further discussed in detail below) and the resulting dough is formed into the desired general shape, an optional outer coating layer may be applied thereto. In accordance with an embodiment of the invention, the outer coating layer is applied and comprises a hydrocolloid gelling agent, or a meltable fat having a melting point between 40° C. to 86° C. Advantageously, this outer coating layer may improve the physical integrity of the shape, as well as function as an environmental barrier. The shaped flavoring composition can be easily coated by techniques conventionally used in confectionery, biscuits, or chocolate coated products, such as a pan coater. For example, the coating process can be carried out by sprinkling and/or successive spraying 1) an aqueous solution or mixture of the hydrocolloid gelling agent, or 2) a liquid form (melted or dissolved) of the fat, onto the outer surface of the core. Another exemplary coating process comprises applying an aqueous solution of the hydrocolloid gelling agent to the outer surface of the core, followed by applying a solid form of a water-soluble ingredient, including fillers such as sodium chloride, sugars, or combinations thereof; opacifying agents; and/or colorants or dyes.

In an embodiment, the outer coating layer comprises a hydrocolloid gelling agent, where the hydrocolloid gelling agent is selected from a water-soluble, hydrocolloid gelling agent, such as gum Arabic, gelatin, guar gum, maltodextrins, etc. An aqueous solution or mixture of the hydrocolloid gelling agent can also further comprise other water-soluble ingredients, including fillers such as sodium chloride, sugars, or combinations thereof; opacifying agents; and/or colorants or dyes. To minimize the added burden of removing excess water, the water-soluble, film forming aqueous solution or mixture is preferably prepared using a minimum amount of water necessary to provide the desired processability and degree of uniform coating. Preferably, the water used for the aqueous solution or mixture is purified water, such as distilled water, deionized water, or reverse osmosis water, but processing water is viable. The coating film thickness can vary depending on the desired effect.

In the instance of using aqueous solution or mixture of the hydrocolloid gelling agent for the outer coating layer, a drying step will advantageously remove excess water to achieve a safe level of water activity. In an embodiment, the drying step is performed at a temperature below the melting point of the edible fat. Water activity (Aw), as known by one skilled in the art, is sometimes referred to as “free” or “available” water in a system that is not bound to non-aqueous constituents. It can properly be defined as the partial vapor pressure of food moisture divided by the equilibrium vapor pressure of pure water at the same temperature. Water activity value can be measured using a LabMaster-aw by Novasina AG (Lachen, Switzerland), at 25° C. Preferably, the water activity (Aw) of the shaped flavoring composition is equal to 0.7 or less. More preferably, the water activity (Aw) of the shaped flavoring composition is equal to 0.6 or less.

In an embodiment, the meltable fat is selected from fats having a melting point between 40° C. to 86° C. Non-limiting sources of meltable fats include carnauba wax, rice bran wax, sunflower wax, candelilla wax, hydrogenated palm oil, bees wax, palm stearin, berry wax, bayberry wax, hydrogenated cottonseed oil, hydrogenated soybean oil, mouton, deodorized palm oil, lard, hydrogenated babassu oil, palmitic acid, stearic acid, or combinations thereof. The meltable fat may also include a mixture of a meltable fat with one or more oils, such that the melting point of the mixture falls with the range of 40° C. to 86° C. Since the meltable fat is applied to the outer surface of the shaped core, it may be preferable to reduce the water content or activity of the core prior to said application of the meltable fat. The meltable fat may be heated to a temperature above its melting point and/or dissolved into a volatile organic solvent. The resulting liquid form of the meltable fat may be applied to the outer surface of the shape core of the shaped flavoring composition, and the volatile solvent, if any, being evaporated.

In accordance with embodiments of the invention, the outer coating layer may have an average thickness in a range from about 0.5 mm to 2 mm.

The total weight of the shaped flavoring composition depends on variety of factors, including density of the dough, the applied compression force during forming, its final moisture content, as well as the density and average thickness of the outer coating layer, if present. Preferably, the density of the shaped flavoring composition is about 1.5 g/cm³ or less, such as 1.4 g/cm³ or less or 1.3 g/cm³ or less. In accordance with an embodiment of the invention, the shaped flavoring composition is provided having a unit mass between 0.5 grams to 10 grams.

In accordance with an embodiment of the invention, a process for preparing the shaped flavoring composition for instant foods is provided, wherein the shaped flavoring composition comprises a core and an optional outer coating layer. The process comprises: forming a premixture comprising a) 10 to 40 weight % of native starch or flour, which is void of any pregelatinized starch; b) 0 to 20 weight % of a plasticizer selected from the group consisting of glycerin, propylene glycol, water, and combinations thereof; c) 30 to 50 weight % of crystalline ingredients selected from sodium chloride, potassium chloride, monosodium glutamate, and combinations thereof; d) 0.5 to 50 weight % of amorphous solid flavor ingredients; and e) 0 to 5 weight % dietary fibers, wherein weight % is based on the weight of the core of the shaped flavoring composition. The native starch or flour, plasticizer, crystalline ingredients, amorphous solid flavor ingredients, and dietary fibers, may be combined and mixed in any order to homogenously disperse the individual components into the premixture. In accordance with an embodiment, no plasticizer (e.g., no added water, no glycerin, and/or no propylene glycol) are intentionally added while forming the premixture, so the premixture is primarily a flowable mixture.

In an embodiment where the plasticizer is an ingredient in the premixture, the plasticizer (e.g., water, glycerin, and/or propylene glycol) and the native starch or flour may be mixed to form a homogenous paste at room temperature, and the remaining crystalline ingredients and amorphous solid flavor ingredients, such as one or more of the rapidly-solubilized, flavor-containing capsules, may be subsequently mixed into the homogenous paste to form the premixture.

The method further comprises mixing 10 to 25 weight % of the melted form of the edible fat (f) into the premixture to form a dough, wherein the edible fat has a melting point between 30° C. to 60° C. Optionally, a drying step may be introduced after the dough is formed (or after the dough is extruded and shaped), to reduce the residual water content or water activity to a desired level. The drying step, if performed, is preferably performed at a temperature less than the melting point of the edible fat (f).

In an embodiment, melted edible fat is added as a liquid to the premixture while mixing, thereby forming a homogeneous, cohesive, and malleable dough. The liquid edible fat may be sprayed, dripped, or poured onto/into the premixture. While edible fat solids could conceivably be added to the premixture and then melted while mixing, this procedural variation typically requires longer mixing times to reach the desired homogeneity. In another embodiment, the edible fat is softened prior to mixing into the premixture. In yet another embodiment, the edible fat is mixed into the premixture in the form of particles (e.g., powder or pieces). Advantageously, if the edible fat is not melted prior to combining with the premixture, the premixture may be warmed and/or the heat generated during the mixing process may facilitate melting of the edible fat.

The mixing may be performed at room temperature or at an elevated temperature to facilitate dispersion of the melted edible fat throughout the premixture. In an embodiment, the mixing may be performed at a temperature near or above the melting temperature of the edible fat. The temperature of the dough may be reduced prior to extrusion, for example, at or near room temperature. If desired, the one or more of the rapidly-solubilized, flavor-containing capsules may be added to the dough before or after extruding the dough, as further explained.

To convert the dough into the flavoring composition having the desired final size and shape, the dough may first be extruded through one or more dies to form an extruded cylindrical dough. For example, in simple embodiment, a circular die of a meat pusher, a syringe pusher, or single screw extruder may be used to form a cylindrical rope of extruded dough having a 1 to 3 cm diameter. Depending on the extrusion equipment, the dough may not be appreciably compressed during the extrusion process, meaning the first density and final density are approximately equal. Depending on the desired size, shape, and density of the final flavoring composition, the compression force used to form the desire shape (e.g., balls, sheets, ribbons, cubes, etc.) of the flavoring composition may be varied.

In a preferred embodiment, a spherical form (e.g., balls) of the flavoring composition is provided. The shaping of the extruded dough into balls may be achieved using equipment commonly used to make a form of fish bait (e.g., boilies). “Boilies” is a name given to hard-boiled baits that were originally introduced to carp angling in the UK during the late 1970's with the sole purpose of keeping nuisance fish from eating away the bait being presented to the carp. Exemplary manufacturing equipment suitable for making spherical flavoring composition are commercially available from Ghebel Carp (Modena, Italy); Anko Food Machine Co., Ltd. (Taipei City, Taiwan); or Shanghai Papa Industrial Co., Ltd. (Shanghai, China). In an embodiment, the spherical flavoring composition has an average diameter in a range from about 1 cm to about 3 cm.

In an embodiment, the spherical flavoring composition has an average sphericity of 0.8 or more. In an embodiment, the sphericity of the dried capsules are in range from about 0.8:1 to 1:1, such as 0.8 or more, 0.85 or more, 0.9 or more, 0.95 or more, or in a range between any two of the foregoing.

Optionally, the method may further comprise applying an outer coating layer to the shaped composition, wherein the outer coating layer comprises g) the hydrocolloid gelling agent, or h) the meltable fat having a melting point between 40° C. to 86° C. Depending on the desired residual water content and/or water activity, an optional drying step may be introduced at prior to or after applying the optional outer coating layer. If performed, the drying is preferably performed at a temperature less than the melting point of the edible fat (f).

In accordance with an embodiment of the invention, the outer coating layer comprises a hydrocolloid gelling agent. The shaped flavoring composition can be easily coated by techniques conventionally used in confectionery, biscuits, or chocolate coated products, such as a pan coater. For example, the coating process can be carried out by sprinkling and/or successive spraying of an aqueous solution comprising the hydrocolloid gelling agent. Another exemplary coating process comprises applying the aqueous solution of the hydrocolloid gelling agent to the outer surface of the core, followed by applying a solid form of a water-soluble ingredient, including fillers such as sodium chloride, sugars, or combinations thereof; opacifying agents; and/or colorants or dyes.

In accordance with an embodiment of the invention, the outer coating layer comprises the meltable fat. The shaped flavoring composition may be dipped or rolled into a molten pool of the meltable fat. Alternatively, the shaped flavoring may be sprayed with liquified meltable fat.

Depending on the desired final level of water content, the shaped flavoring composition (in its final shape and size) can be subjected to a drying step using dry, ambient air (e.g., 20-25° C.) or in a ventilated oven for example or on a drying strip. The temperature of the drying environment should be lower than the melting point of the edible fat to avoid melting of the fat ingredient, which may affect the shape or processability of the flavoring composition. In an embodiment, drying is performed in a current of air at controlled temperature and humidity, or under vacuum. The relative humidity of the drying air may be in a range from 20% to 60%, preferably 30 to 50%; the temperature of the drying air is in a range from 15° C. to 30° C. For measuring the water content of the flavoring composition, a Karl Fisher titrator (Mettler model DL18) is suitable. In accordance with embodiments of the present invention, the shaped flavoring composition has a total moisture content less than 10 weight %, wherein weight % is based on the weight of the shaped flavoring composition. In accordance with embodiments of the present invention, the shaped flavoring composition has a water activity (Aw) of 0.7 or less. Preferably, the shaped flavoring composition has a water activity (Aw) of 0.6 or less.

According to a preferred embodiment, the shaped flavoring composition is characterized as having a dried hardness of 150 grams-force to 2,000 grams-force, after a 7-day aging period, stored at room temperature, at approximately 60% RH. The dried hardness is measured using a TA.XTplus texture analyzer from Stable Micro System Ltd. (Surrey, UK) in compression mode with a 5 Kg load cell; Probe: P0.5—½ diameter DELRIN® cylinder; cylinder speed 0.5 mm/sec; resolution of 0.01 Kg (10 g). The sample is positioned on the TA.XT plus device between the base and the probe. Vertical compressive force is applied for a probe displacement of 1 mm. The probe is then retracted to its zero displacement. Vertical compressive force is then continuously reapplied to the probe (a second compression) until the sample breaks and crumbles. Simultaneous to all probe motion, the built-in gauges records force (in grams (g)) and position (in millimeter (mm)).

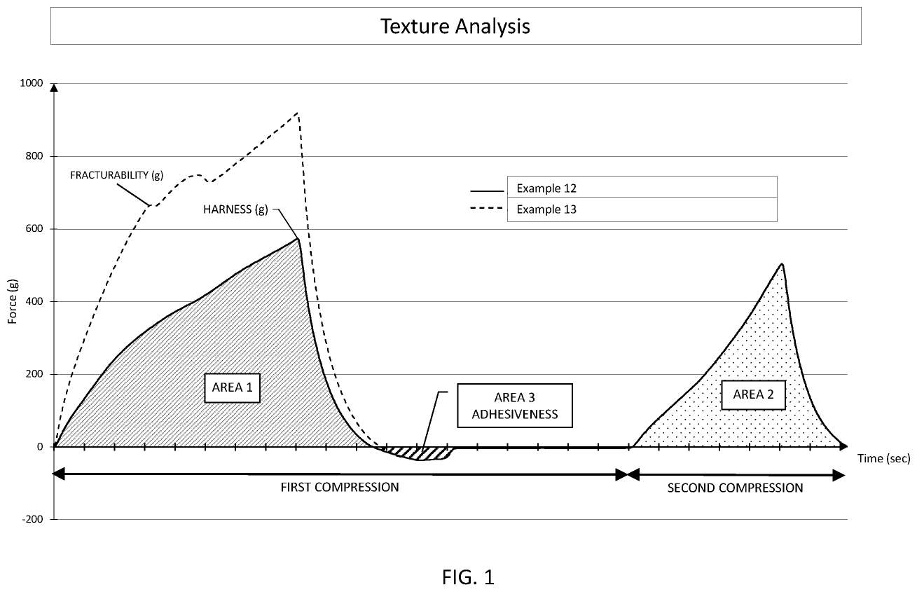

Referring to FIG. 1, which shows a typical plot of texture analysis performed on a spherically-shaped flavoring composition. Hardness is the maximum force of the first compression to 1 mm (at approximately 2 seconds). Fracturability value is the force at the first peak, if the sample breaks during the first compression. Cohesiveness is the area of work during the second compression divided by the area of work during the first compression (Area 2/Area 1). Adhesiveness is the negative area recorded during the retraction of the probe (between 3 and 4 seconds) (Area 3). Resilience is calculated by dividing the upstroke energy of the first compression by the downstroke energy of the first compression (Area 5/Area 4). Texture analysis is performed on the shaped flavoring composition, after a 7-day aging period, stored at room temperature, at approximately 60% RH.

In comparison to standard bouillon cubes (MAGGI™, Nestle (Vevey, Switzerland)), the shaped flavoring composition of the present invention is characterized as having much lower hardness and significantly lower density. Subjecting MAGGI™ bouillon cubes to the foregoing texture analysis described above, the hardness was 19,039 grams-force. Furthermore, the density of the MAGGI™ bouillon cubes was calculated to be about 2 g/cm³, whereas the shaped flavoring compositions of the present invention are all less than 1.5 g/cm³.

In accordance with embodiments of the invention, the shaped flavoring composition of the invention are “quick-disintegrating”, meaning that the shaped flavoring composition disintegrates after soaking in water (one substrate in approximately 120 ml of water) for three minutes at 90° C., followed by moderate stirring with a spoon for 15 seconds. [Evaluated on the following scale: 1—Very little dissolves (nooball integrity maintained); 2—Coating solubilization; 3—Partial solubilization/disintegrations; 4—Full disintegration (insoluble particles such as vegetables/herbs particles); and 5—Full solubilization (no particles)]. In an embodiment, where the shaped flavoring composition comprises one or more of the rapidly-solubilized, flavor-containing capsule(s) included in the core of the shaped flavoring composition, it should be appreciated that the dissolution (solublization) of said one or more rapidly-solubilized capsules will not begin until the surrounding material has substantially disintegrated.

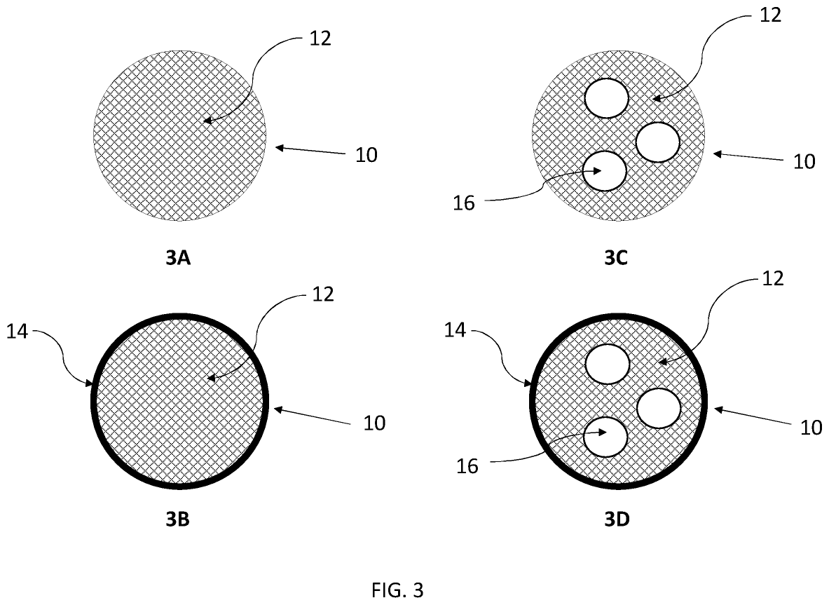

Referring to FIG. 3, cross-sectional views of exemplary embodiments of the shaped flavoring compositions (10) are shown. Cross-sectional views 3A and 3C are without an outer coating layer surrounding the core (12), whereas cross-sectional views 3B and 3C include an outer coating layer (14). In an embodiment, cross-sectional views 3C and 3D show the presence of one or more rapidly-solubilized, flavor-containing capsules (16).

### EXAMPLES

Method of preparation of Examples 1-2: Prepare a powdered flavoring mixture (A); Mix the powdered flavoring mix (A) with native starch (B1), dietary fiber (B1), and other flavor ingredients (B) to form a premixture; Heat the fat (C) above melting point (e.g., 40° C.); Add the melted fat (C) to the premixture and knead until a homogeneous dough is obtained; Roll or extrude the dough into a 1 cm (diameter) cylinder; Cut the cylindrical dough and shape portions into balls; Prepare a coating material by solubilizing gum Arabic (E) in water; Apply the coating material to the balls in order to obtain a thin coating; Apply salt or sugar (F) to wet balls; and Dry to the desired water activity or moisture content, and after a 7-day aging period, stored at room temperature, at approximately 60% RH. Disintegration testing of the final shaped flavoring compositions proved to be acceptable with scale ranging from 3-5.

TABLE 1
Formulations for Examples 1 and 2.

| | | | Ex 1 | Ex 2 |
|---|---|---|---|---|
| | | | (wt %) | (wt %) |
| Core | A | Beef Pho flavor 1^{a} | | 44.1 |
| | A | Arrabiata powder flavor^{b} | 3.6 | |
| | B1 | Rice fiber | 0.7 | 1.1 |
| | B1 | Native maize starch | 17.8 | 25.6 |
| | B | Fine salt | 14.2 | |
| | B | Tomato powder | 10.7 | |
| | B | Parsley | 1.1 | |
| | C | Hydrogenated coconut oil | 14.3 | |
| | | (mp = 30 − 38° C.) | | |
| | C | Beef Fat (mp = 38 − 43° C.) | | 21.2 |
| Coating | D | Gum arabic | 0.7 | 2.7 |
| | E | Water (residual) | 5.3 | 4.4 |
| | F | Colorant | 0.04 | |
| | F | Salt | 14.4 | |
| | F | Sugar | 14.4 | |

^{a}70-75 wt % Crystalline ingredients.
^{b}69-78 wt % Crystalline ingredients.

Method of preparation of Examples 3-6: Mix the flour (A) and the plasticizer (B) to form a paste; Mix the crystalline and amorphous flavoring ingredients (C) into the paste to form a premixture; Heat the fat (D) above melting point (e.g., 40° C.); Add the melted fat to the premixture and knead until a homogeneous dough is obtained; Roll or extrude the dough into a 1 cm (diameter) cylinder; Cut the cylindrical dough and shape portions into balls. Prepare a coating material by solubilizing gum Arabic (E) in water; Apply the coating material to the balls in order to obtain a thin coating; Apply salt or sugar (F) to wet balls; and Dry to the desired water activity or moisture content. Water activity and texture analysis was performed on the final shaped flavoring compositions. Disintegration testing of the final shaped flavoring compositions proved to be acceptable with scale ranging from 3-5.

TABLE 2
Formulations for Examples 3-6.

| | | | Ex 3 | | Ex 4 | | Ex 5 | | Ex 6 | |
|---|---|---|---|---|---|---|---|---|---|---|
| | | | Core | Total | Core | Total | Core | Total | Core | Total |
| | | | (wt %) | (wt %) | (wt %) | (wt %) | (wt %) | (wt %) | (wt %) | (wt %) |
| Core | A | Flour^{a} | 27.8 | 24 | 29 | 26 | 30 | 27 | | |
| | A | Flour^{b} | | | | | | | 27 | 19 |
| | B | Plasticizer (water) | 10.7 | 0 | 10 | 0 | 10 | 0 | 12 | 0 |
| | C | Beef Pho flavor 2^{c} | 28.5 | 25 | | | 27 | 24 | | |
| | C | Beef Pho flavor 3^{d} | | | 28 | 25 | | | | |
| | C | Fine salt | 17.1 | 15 | 17 | 15 | 16 | 15 | 18 | 12 |
| | D | Beef Fat | 15.8 | 14 | 15 | 14 | 15 | 14 | 16 | 12 |
| | | (mp = 38-43° C.) | | | | | | | | |
| Coating | E | Gum arabic | | 1.5 | | 1.5 | | 1.5 | | 0.2 |
| | F | Sugar | | 15 | | 15 | | 15 | | 28 |

| | | | | |
|---|---|---|---|---|
| Water activity | 0.61 | 0.60 | 0.64 | 0.57 |
| Hardness (g) | 214 | 206 | 174 | 450 |
| Adhesiveness (g · sec) | −0.004 | −0.29 | −0.001 | −0.011 |
| Cohesiveness | 0.072 | 0.141 | 0.096 | 0.82 |
| Resilience | 3.17 | 0.043 | 0.166 | 2.78 |
| Fracturability (g) | 93.997 | — | 62.115 | 171.129 |

^{a}Wheat flour 11% protein;
^{b}Quinoa flour 24% protein;
^{c}59.6 wt % crystalline ingredients, 37.9 wt % amorphous solid flavor ingredients;
^{d}58.6 wt % crystalline ingredients, 37.9 wt % amorphous solid flavor ingredients.

Method of preparation of Examples 7-10: Mix the flour (A) and the plasticizer (B) to form a paste; Mix the crystalline and amorphous flavoring ingredients (C) into the paste to form a premixture; Heat the fat (D) above melting point (e.g., 40° C.); Add the melted fat to the premixture and knead until a homogeneous dough is obtained; Roll or extrude the dough into a 1 cm (diameter) cylinder; Cut the cylindrical dough and shape portions into balls. Coating process for examples 7 and 8: Prepare a coating material by solubilizing gum Arabic (E) in water; Apply the coating material to the balls in order to obtain a thin coating; Apply salt or sugar (F) to wet balls; and Dry to the desired water activity or moisture content. Coating process for examples 9 and 10: Melt the meltable fat; and Apply a thin coating of the melted fat to balls. Water activity and texture analysis was performed on the final shaped flavoring compositions. Disintegration testing of the final shaped flavoring compositions proved to be acceptable with scale ranging from 3-5.

TABLE 3
Formulations for Examples 7-10.

| | | | Ex 7 | | Ex 8 | | Ex 9 | | Ex 10 | |
|---|---|---|---|---|---|---|---|---|---|---|
| | | | Core | Total | Core | Total | Core | Total | Core | Total |
| | | | (wt %) | (wt %) | (wt %) | (wt %) | (wt %) | (wt %) | (wt %) | (wt %) |
| Core | A | Flour^{a} | | | | | 28 | 25 | 28 | 24 |
| | A | Flour^{c} | 24 | 17 | | | | | | |
| | A | Flour^{d} | | | 23 | 16 | | | | |
| | B | Plasticizer (water) | 24 | 0 | 26 | 0 | 11 | 11 | 11 | 10 |
| | C | Beef Pho flavor 2^{e} | 23 | 17 | 23 | 16 | 29 | 26 | 29 | 24 |
| | C | Fine salt | 15 | 11 | 15 | 10 | 17 | 16 | 17 | 15 |
| | D | Beef Fat | 14 | 10 | 14 | 10 | 15 | 14 | 11 | 10 |
| | | (mp = 38-43° C.) | | | | | | | | |
| Coating | E | Gum arabic | | 0.2 | | 0.2 | | | | |
| | F | Sugar | | 31 | | 32 | | | | |
| | G | Palmitic acid | | | | | | 8 | | |
| | | (mp = 63-65° C.) | | | | | | | | |
| | G | Stearic acid | | | | | | | | 15 |
| | | (mp = 65-69° C.) | | | | | | | | |

| | | | | |
|---|---|---|---|---|
| Water activity | 0.59 | 0.59 | 0.67 | 0.67 |
| Hardness (g) | 636 | 149 | 218 | 322 |
| Adhesiveness (g · sec) | −0.004 | −0.001 | −0.101 | −0.206 |
| Cohesiveness | 0.073 | 0.116 | 0.065 | 0.183 |
| Resilience | 1.087 | 0.924 | 0.202 | 0.797 |
| Fracturability (g) | 414.781 | 124.28 | — | — |

^{a}Wheat flour 11% protein;
^{c}Rice Flour 51% protein;
^{d}Quinoa flour 24% protein;
^{e}59.6 wt % crystalline ingredients, 37.9 wt % amorphous solid flavor ingredients.

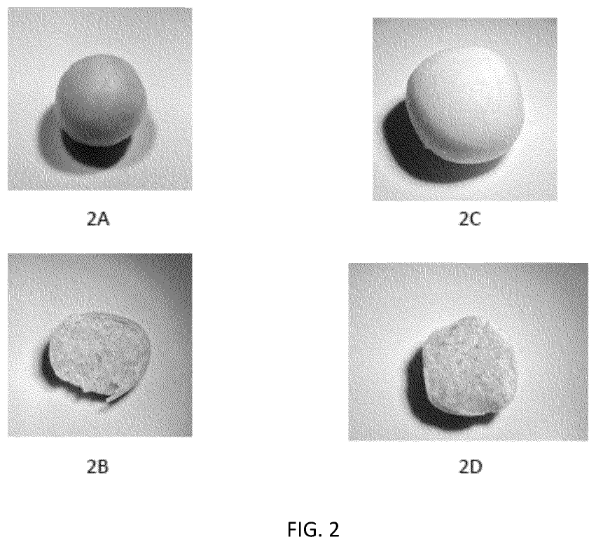

Method of preparation of Examples 11-13: Mix the flour (A) and the plasticizer (B) to form a paste; Mix the crystalline and amorphous flavoring ingredients (C) and (optionally) rice hull fiber (C1) into the paste to form a premixture; Heat the fat (D) above melting point (e.g., 40° C.); Add the melted fat to the premixture and knead until a homogeneous dough is obtained; Roll or extrude the dough into a 1 cm (diameter) cylinder; Cut the cylindrical dough and shape portions into balls. Coating process for examples 11, 12, and 13: Melt the meltable fat; and Apply a thin coating of the melted fat to the balls. Water activity and texture analysis was performed on the final shaped flavoring compositions. Disintegration testing of the final shaped flavoring compositions proved to be acceptable with scale ranging from 3-5. In FIG. 2, photographs of the shaped flavoring compositions of Examples 12 and 13 (2A and 2C, respectively), along with cross-sectionally cut portions (2B and 2D, respectively), are shown.

TABLE 4
Formulations for Examples 11-13.

| | | | Ex 11 | | Ex 12 | | Ex 13 | |
|---|---|---|---|---|---|---|---|---|
| | | | Core | Total | Core | Total | Core | Total |
| | | | (wt %) | (wt %) | (wt %) | (wt %) | (wt %) | (wt %) |
| Core | A | Flour^{a} | 28 | 25 | 28 | 25 | 26 | 22 |
| | B | Plasticizer (water) | 11 | 10 | | | 10 | 8 |
| | B | Plasticizer (glycerin) | | | 11 | 10 | | |
| | C | Beef Pho flavor 2^{b} | 29 | 25 | 29 | 26 | 27 | 23 |
| | C | Fine salt | 17 | 15 | 17 | 16 | 16 | 14 |
| | C1 | Rice hull fiber | | | | | 5 | 4 |
| | D | Beef Fat | 15 | 14 | 16 | 15 | 15 | 13 |
| | | (mp = 38-43° C.) | | | | | | |
| Coating | E | Bees wax | | 11 | | 9 | | 17 |
| | | (mp = 61-65° C.) | | | | | | |

| | | | |
|---|---|---|---|
| Water activity | 0.68 | 0.23 | 0.67 |
| Hardness (g) | 466 | 441 | 787 |
| Adhesiveness (g · sec) | −12.66 | −5.87 | −12.75 |
| Cohesiveness | 0.239 | 0.115 | 0.165 |
| Resilience | 0.084 | 0.033 | 0.055 |
| Fracturability (g) | — | — | — |

^{a}Wheat flour 11% protein;
^{b}59.6 wt % crystalline ingredients, 37.9 wt % amorphous solid flavor ingredients.

While the invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative product and/or method and examples shown and described. The various features of exemplary embodiments described herein may be used in any combination. Accordingly, departures may be made from such details without departing from the scope of the general inventive concept.

1. A shaped flavoring composition comprising:
a core comprising:
a) 10 to 40 weight % of native starch or flour void of any pregelatinized starch;
b) 0 to 20 weight % of a plasticizer selected from the group consisting of glycerin, propylene glycol, water, and combinations thereof;
c) 30 to 50 weight % of crystalline ingredients selected from sodium chloride, potassium chloride, monosodium glutamate, and combinations thereof;
d) 0.5 to 50 weight % of amorphous solid flavor ingredients;
e) 0 to 5 weight % dietary fibers;
f) 10 to 25 weight % of an edible fat having a melting point between 30° C. to 60° C.; and
optionally, an outer coating layer applied to the core, the layer comprising
a) a hydrocolloid gelling agent, or
b) a meltable fat having a melting point between 40° C. to 86° C., wherein ingredients (a)-(f) are mixed into a dough, extruded, and formed into a shape of the core, and optionally the outer coating layer is applied to the core;
wherein weight % is based on the weight of the core of the shaped flavoring composition; and
wherein the shaped flavoring composition has a hardness of from 150 grams-force to 2,000 grams-force.

2. The shaped flavoring composition according to claim 1, further comprising a coloring agent.

3. The shaped flavoring composition according to claim 2, wherein the coloring agent is a powder, a liquid, or a substance dissolved in liquid oil.

4. The shaped flavoring composition according to claim 1, wherein the shape is selected from a sheet, a cube, a cylinder, or a sphere.

5. The shaped flavoring composition according to claim 1, wherein the shape is a sphere having a sphericity of at least 0.80.

6. The shaped flavoring composition according to claim 1, comprising from 0.5 to 5 weight % of the dietary fibers.

7. The shaped flavoring composition according to claim 1, wherein the outer coating layer comprises the hydrocolloid gelling agent, and further includes a salt, a sugar, or a combination thereof.

8. The shaped flavoring composition according to claim 1, wherein the outer coating layer is applied to the core, and the outer coating layer comprises the meltable fat.

9. The shaped flavoring composition according to claim 1, wherein the outer coating layer has an average thickness in a range from about 0.5 mm to 3 mm.

10. The shaped flavoring composition according to claim 1, having a unit mass between 0.5 grams to 10 grams.

11. A process for preparing the shaped flavoring composition according to claim 1, comprising:
forming a premixture by mixing:
a) 10 to 40 weight % of native starch or flour, which is void of any pregelatinized starch;
b) 0 to 20 weight % of a plasticizer selected from the group consisting of glycerin, propylene glycol, water, and combinations thereof;
c) 30 to 50 weight % of crystalline ingredients selected from sodium chloride, potassium chloride, monosodium glutamate, and combinations thereof; and
d) 0.5 to 50 weight % of amorphous solid flavor ingredients;
e) 0 to 5 weight % dietary fibers;
mixing 10 to 25 weight % of a melted form of an edible fat (f) into the premixture to form a dough, wherein the edible fat has a melting point between 30° C. to 60° C.;
extruding and forming the dough into the shape of the core of the shaped flavoring composition; and
optionally, applying the outer coating layer to the core of the shaped flavoring composition, wherein the outer coating layer comprises:
g) the hydrocolloid gelling agent, or
h) the meltable fat having the melting point between 40° C. to 80° C.;
wherein weight percent is based on the weight of the core of the shaped flavoring composition; and
wherein the shaped flavoring composition has a hardness of 150 grams-force to 2,000 grams-force.

12. The process as claimed in claim 11, wherein the edible fat is melted prior to mixing the edible fat into the premixture.

13. The process according to claim 11, further comprising mixing a coloring agent into the premixture.

14. The process according to claim 11, wherein the shape is a sphere.

15. The process according to claim 14, wherein a sphericity of the sphere is at least 0.80.
